(19) United States
(12) Patent Application Publication
(10) Pub. No.: US 2017/0318796 A1
(43) Pub. Date: Nov. 9, 2017

(54) SYSTEM FOR CONTROLLING PESTS POPULATION AND METHOD OF MANAGING SAME

(71) Applicants: Alexander VAISBLAT, Wellington (NZ); Michael John WILLOUGHBY, Wellington (NZ)

(72) Inventors: Alexander VAISBLAT, Wellington (NZ); Michael John WILLOUGHBY, Wellington (NZ)

(21) Appl. No.: 15/586,363

(22) Filed: May 4, 2017

Related U.S. Application Data
(60) Provisional application No. 62/332,011, filed on May 5, 2016.

(51) Int. Cl. A01M 25/00; G08B 21/18; A01M 31/00

(52) U.S. Cl. CPC A01M 25/004; A01M 31/002; G08B 21/18

(57) ABSTRACT

A bait station for trapping pets may include: a housing, a plurality of open channels located in the housing, such that the plurality of open channels may be configured to allow the entrance and the exit of pests to and from an open space within the housing and a bait holder located in the open space.

### CROSS REFERENCE TO RELATED APPLICATIONS

This application claims the benefit of U.S. Provisional Patent Application No. 62/332,011, filed on May 5, 2016 and entitled “SYSTEM FOR CONTROLLING PESTS POPULATION AND METHOD OF MANAGING SAME”, which is incorporated in its entirety herein by reference.

### BACKGROUND OF THE INVENTION

Controlling populations of pests such as rodents and snakes becomes a major problem in populated areas. Municipalities spend both money and manpower to control pests' populations. The current methods includes manual inspection of traps placed in required places, such as schools, hospitals, warehouses and the like. Inspectors must visually inspect each trap to see if a pest was already trapped. Currently, there is no system that may allow the inspectors to know if a pest was trapped in a particular trap, prior to the inspectors reaching and inspecting the trap.

### SUMMARY OF THE INVENTION

Some embodiments of the invention may be related to a bait station for trapping pets. The bait station may include: a housing, a plurality of open channels located in the housing, such that the plurality of open channels may be configured to allow the entrance and the exit of pests to and from an open space within the housing, and a bait holder located in the open space.

Some embodiments of the invention may be related to a computer implemented method that may be executed by a central managing unit for controlling pests' population. The method may include: receiving a first indication of pest activity at a specific bait station; receiving a location of the pest bait station from which the indication was received; receiving localization information of one or more user devices; and sending an alert to the user device based on receipt of the first indication.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram of a system for controlling pests' population according to some embodiments of the invention;

FIG. 2A-2C are illustrations of bait stations according to some embodiments of the invention;

FIGS. 3A-3C are illustration of different configurations of a bait station according to some embodiments of the invention; and

FIG. 4 is a flowchart of a method of managing a system for controlling pests' population according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Some embodiments of the invention may be directed to a system for controlling the population of pests (e.g., rodents, reptiles, or the like) and methods for managing such system. According to some embodiments, the system may include a plurality of pest bait stations and a central managing unit to manage the plurality of pest bait stations. The pest bait stations may be placed at various desired locations where the number of pests is desired to be reduced, for example, in gardens, on trees, or in basements, warehouses or the like. Each pest bait station may include housing and a plurality of open channels located in the housing. In some embodiments, the plurality of open channels may be configured to allow the entrance and the exit of pests, to and from an open space within the bait station housing. In some embodiments, the bait station may further include a bait holder located in the open space.

In some embodiments, the bait station may further include one or more sensors configured to sense an activity of pests in the bait station. The bait station may further include a controller for receiving an indication of the pests' activity and sending the indication to the central managing unit via a communication unit.

The central managing unit may be configured to receive indication of the pests' activity in the bait station and send an alert to a user device based on receipt of the indication. The central managing unit may further receive the location of each bait station (e.g., a certain address, geographic coordinates or the like) and localization information of a user device (e.g., coordinates from a Global Positioning System (GPS) of a smart phone or another portable computing device) and may send the user (e.g., a pest controller) an alert to change the bait in the bait station.

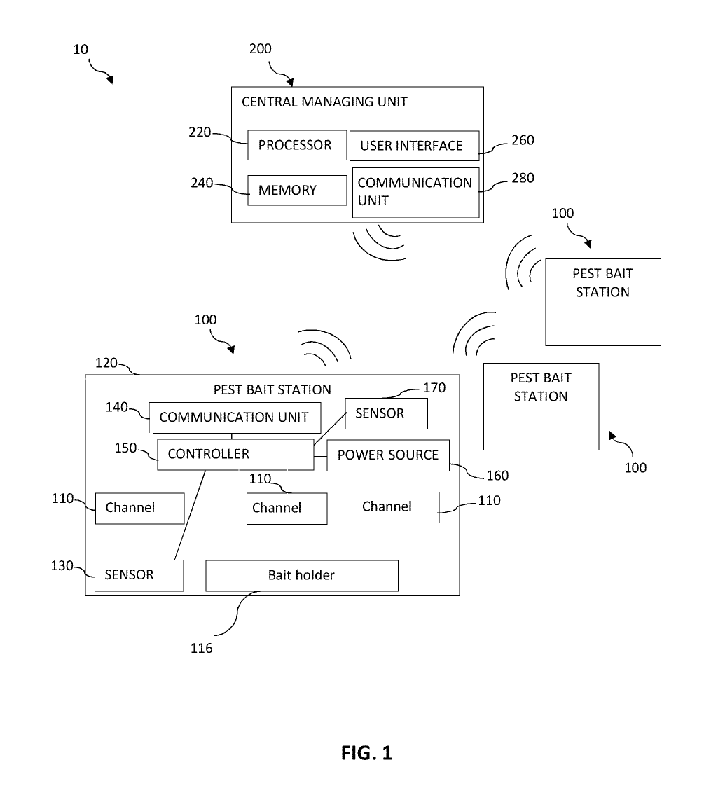

Reference is made to FIG. 1 which is a block diagram of a system for controlling pests' population according to some embodiments of the invention. System 10 may include a central managing unit 200 and a plurality of pests bait stations 100 in active communication with central managing unit 200. Central managing unit 200 may include a processor 220 a memory 240, user interface 260 and a communication unit 280. In some embodiments, central managing unit 200 may be remotely located from pest bait stations 100. For example, central managing unit 200 may be located at the headquarters of the pest controllers, and pest bait stations 100 may each be located at areas that may have a potential rodent infestation.

Processor 220 may be, for example, a central processing unit (CPU), a chip or any suitable computing or computational device. Memory 240 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 240 may be or may include a plurality of, possibly different memory units.

Central managing unit 200 may be included in a desktop computer, laptop computer, a tablet, a mainframe computer, a cloud computing or the like. Processor 220 may be configured to carry out methods according to some embodiments of the present invention, for example, executing instructions stored in a memory such as memory 240 to control and manage a plurality of bait stations 100. Memory 240 may store any executable code, e.g., an application, a program, a process, task or script. Memory 240 may be located on a cloud computing service. The executable code may include codes for controlling and managing a system for controlling pests' population or any other codes or instruction for executing methods according to embodiments of the present invention. The executable code may be executed by processor 220 possibly under control of an operating system.

User interface 260 may be or may include a screen (e.g., a monitor, a display, a CRT, etc.), a pointing device (e.g., a mouse, a touch screen or a pad) and an audio device. User interface 260 may include or be associated with other input devices such as, a keyboard. User interface 260 may include audio device such as one or more speakers, earphones and/or any other suitable audio devices. It will be recognized that any suitable number of output devices may be included in user interface 260. Any applicable input/output (I/O) devices may be connected to central unit 200. For example, a wired or wireless network interface card (NIC), a modem, printer or facsimile machine, a universal serial bus (USB) device or external hard drive may be included in user interface 260.

Central managing unit may further include communication unit 280. Communication unit 280 may be in active communication with each bait station 100 included in device 10. Communication unit 280 may include any transceiver known in the art to wirelessly communicate between two points, for example, communication unit 280 may include: GSM modem, radio transceiver, Wi-Fi communication device, Bluetooth communication device, or the like.

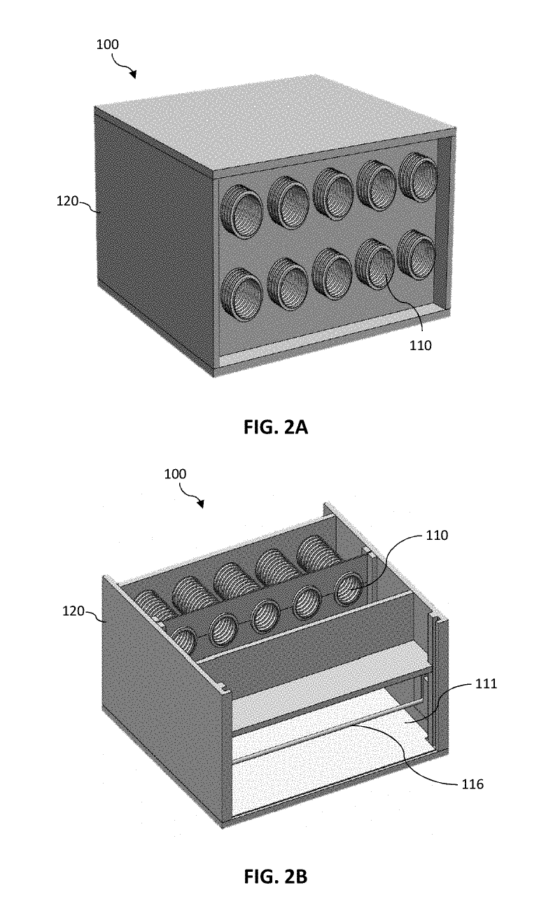

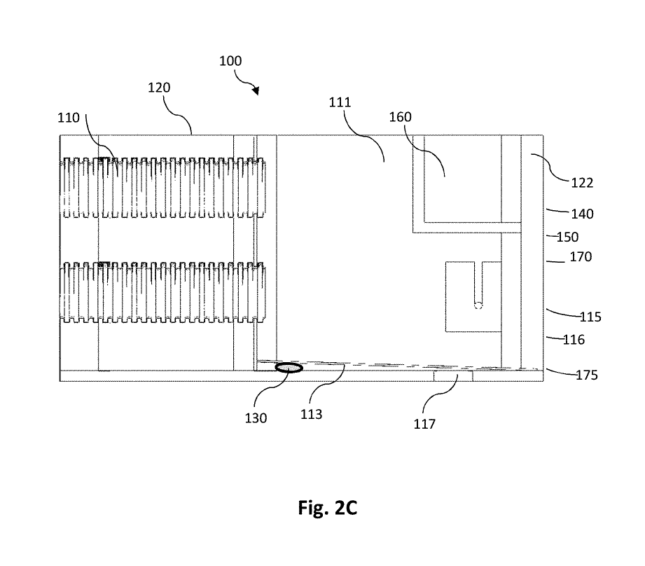

In some embodiments, each bait station 100 may include a housing 120, a plurality of open channels 110 located in the housing, and a bait holder 116. The open channels may be configured to allow the entrance and the exit of pests to and from an open space (e.g., open space 111 illustrated in FIGS. 2B-2C) within housing 120. In some embodiments, bait holder 116 may be located inside space 111. Bait station 100 may further include communication unit 140 and a controller 150 that may be configured to receive signals from one or more sensors 130 and/or 170 and send indications of pests' activity in station 100 to central managing unit 200 via communication unit 140. In some embodiments, bait station 100 may further include a power source 160 for supplying power to the electrical components of bait station 100.

Reference is made to FIGS. 2A-2C which are schematic illustrations of a bait station according to some embodiments of the invention. FIGS. 2A and 2B are isometric views of the exterior and interior of a bait station, and FIG. 2C is a cross sectional view. Bait station 100 may include a housing 120 for holding the various components of the bait station. Housing 120 may be made from any suitable material, such as various alloys, plastics and wood. Housing 120 may include a removable cover 122. Removable cover 122 may be located opposite to the opening of open channels 110 or at any other wall of housing 120.

In some embodiments, housing 120 may include a pests' passage 113 for leading the pest towards bait holder 116. Pests' passage 113 may have a form of a declining floor panel gradually declining from the exit (e.g., internal opening) of channels 110 towards bait holder 116. The declining floor panel may be locate in the bottom of internal space 111 and may be set to lead the pest to the bait held by holder 116. The declining floor panel may include holes for draining secretions originated from the pests. Housing 120 may further include a drainer 117 for draining the secretions. Drainer 117 may be located beneath the floor panel.

In some embodiments, bait holder 116 may be supported on a support 115 attached to either pests' passage 113 or a wall of housing 120. An exemplary bait holder may have a form of a rod. However, the invention is not limited to such a particular form. An operator (e.g., a pests' controller) may easily replace the baits held by bait holder. For example, the operator may first place non-poisoned bait on bait holder 116 and then after several days replace the non-poisoned bait with a poisoned one.

In some embodiments, a machine readable element 175 (e.g., an RFID tag) may be attached to the bait placed on bait holder 116, to bait holder 116 itself to the end wall of hosing 120 or else, every time a specific bait is placed/replaced on bait holder 116. Upon touching the bait by the pest, sensor 130 or controller 150 may activate machine readable element 175. The machine readable element may include information such as: the type of bait, weight of bait, manufacturer of bait, unique ID of bait and the like. The machine readable tag may allow identifying specific baits or specific poisons (e.g., a rodenticide). A tag reader (e.g., an RFID reader- not illustrated) may be located inside housing 120 for reading the ID of the specific bait form the machine readable tag. In some embodiments, the end cap also has provision for a concave shaped cup to fit into it and provide a way to dispense liquid bait.

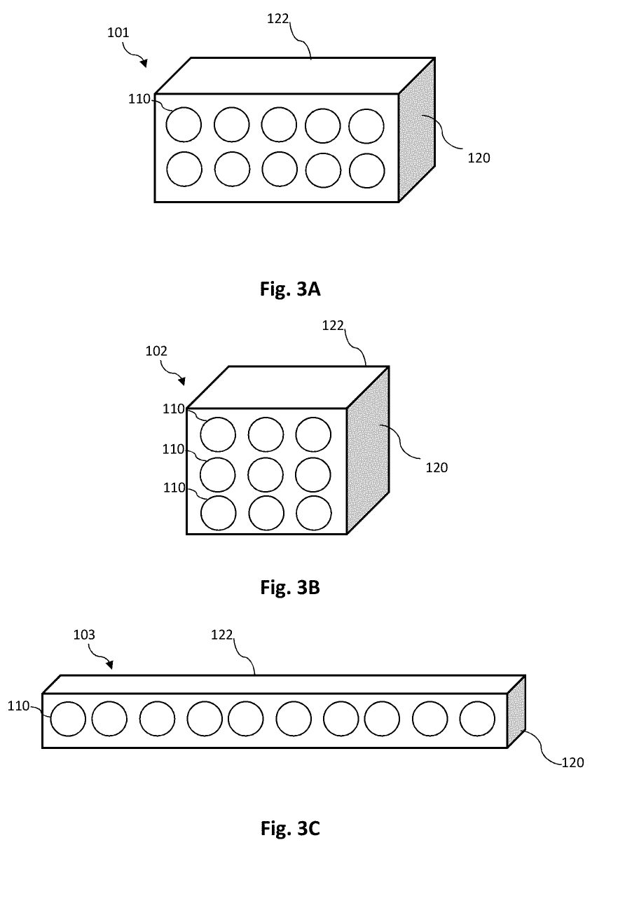

Channels 110 may be arranged in an array form, held by housing 120. Some exemplary arrays are illustrated in FIGS. 3A-3C. Channels 110 may be open in both ends, allowing the pests to go in and out bait station 100. Channels 110 may have a length shorter than the length of housing 120 Channels 110 may have an external opening and internal opening Channels 110 internal opening may lead to an internal space 111 within housing 120. Channels 110 may have cylindrical geometry (as illustrated), rectangular geometry, prismatic geometry or the like Channels 110 may be made from any suitable material, such as various plastics, metal alloys or the like.

In some embodiments, additional components of bait station 100 may be located in internal space 111. For example, one or more sensors 130 and/or 170 for detecting indications for pests' activity. Sensor 130 may be or may include a piezoelectric device or any other electronic component configured to sense the presence of a pest in station 100. For example, sensor 130 may sense vibrations in station 100 caused by a rodent climbing into channel 110. In some embodiments, sensor 130 may be located beneath pests' passage 113. Such a sensor may sense a pest walking in pests' passage 113. In some embodiments, sensor 170 located elsewhere in internal space 111 may sense the body heat (e.g., an infrared (IR) sensor) of a rodent. In some embodiments, sensor 130 and/or sensor 170 may include: a sound based sensor, an ultrasound based sensor, heat based sensor, vibration based sensor, movement based sensor, radio frequency based sensor, light based sensor, laser based sensor and/or weighing scale. Exemplary electronic components of sensors 130 and/or 170 may be embedded in a polymeric (or any other dielectric material) board and inserted into or attached to housing 120 (e.g., to the polymeric foam, folded aluminum sheet and the like).

In some embodiments, other electronic components such as controller 140, communication unit 150 and a power source 160 may also be located in internal space 111. The electronic components may be held (e.g., embedded) in a polymeric board (e.g., a PCB).

Communication unit 140 may be or may include any transceiver known in the art to wirelessly communicate controller 150 and central managing unit 200, for example, communication unit 140 may include: GSM modem, radio transceiver, Wi-Fi communication device, Bluetooth communication device, or the like.

According to some embodiments, bait station 100 may further include a power source 160. Power source 160 may be configured to provide power to all the electronic components of pest trap 100. For example, power source 160 may provide power to one or more sensors 130, communication unit 140, one or more sensors 170 and controller 150.

Reference is made to FIGS. 3A-3C which are illustrations of exemplary pest bait stations according to some embodiments of the invention. A pest bait station 101 illustrated in FIG. 3A may include housing 120 configured to hold an array of channels 110. In the exemplary embodiment of FIG. 3A, two rows of five channels 110 are illustrated. Housing 120 may include a removable cover 122 configured to allow simple access for replacing bait or removing pests. Removable cover 122 may slide out, tilt off, or otherwise open to allow access to internal space 111 of housing 120. Removable cover 122 may include the entire side wall of housing 120 or a portion of the side wall. Trap 101 may further include at least one of: one or more sensors 130 and/or 170, communication unit 140, controller 150, power source 160, and any other component included in bait station 100 disclosed above.

Pest bait stations 102 and 103 illustrated in FIGS. 3B and 3C are additional exemplary configurations of a bait station and include substantially the same elements of bait station 101. Channels 110 may be arranged in a 3×3 array illustrated in FIG. 3B or in a “train”-like array illustrated in FIG. 3C. Both stations 102 and 103 may include housing 120, each having a removable cover 122.

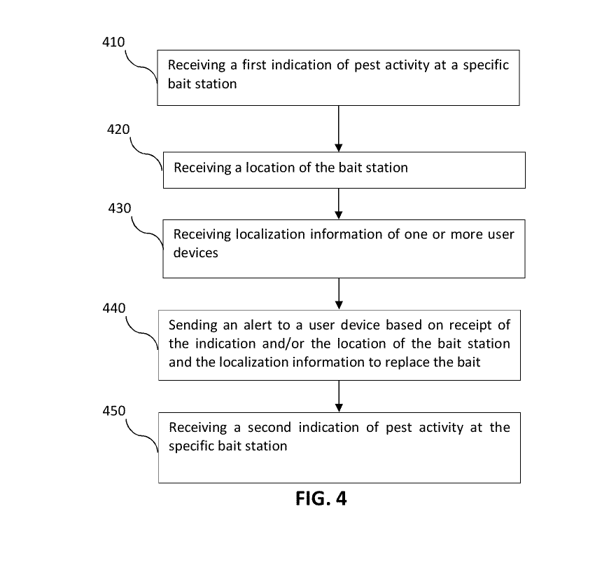

Reference is made to FIG. 4 which is a flowchart of a method of managing a system for controlling pests' population according to some embodiments of the invention. The embodiments of FIG. 4 may be performed by central managing unit 200 or by any other suitable controller. In operation 410, embodiments may include receiving a first indication of pest activity at a specific bait station 100. When a pest(s) enters a channel 110 or internal space 111 of station 100 at least one sensor 130 or 170 may send a signal to controller 150. Controller 150 may send a first indication of pest activity at a specific bait station to central managing unit 200 via communication unit 140. The first activity may be detected after a first bait (e.g., non-poisoned bait) was placed on the bait holder by a user. The first bait may encourage pests to come and feed “safely” and get acquainted with bait station 100.

In operation 420, some embodiments may include receiving a location of the pest bait station 100 from which the indication was received. Processor 220 may receive an ID number of the bait station. The ID number may be sent by controller 150 together with the indication of pest activity. Processor 220 may then use a lookup table to correlate between the location of the bait station and the ID number. The location of the bait station may be initially received from a user device of the user placing the bait station. For example, the user may use a mobile user device to communicate with managing unit 200 and may send to unit 200 information associating pest bait station 100 ID number with the bait station location. Additionally or alternatively, each bait station may include a localization sensor (e.g., a GPS antenna) that may be connected to controller 150. Accordingly, controller 150 may send to managing unit 200 localization information (e.g., geographical coordinates) related to the bait station together with the indication of pest activity.

In operation 430, some embodiments may include receiving localization information of one or more user devices. Managing unit 200 may receive the location of a smartphone (or any other mobile device) of one or more pest controllers, for example, using GPS signals. In operation 440, some embodiments may include sending an alert to the user device based on receipt of the first indication and the received location. The system may alert at least one user by sending an alert to the user's mobile device that a pest activity was detected at a particular bait station 100. The alert may include the duration (for how long the activity is detected) and intensity (how many pests) and the location of the trap. In some embodiments, central managing unit 200 may be configured to select the user device to which the alert is to be sent based on the location of the user device. Processor 220 may calculate the distance (e.g., traveling distance, or traveling time) between all potential user devices and the particular bait station, and to select to send the alert to the user device being in the shortest and/or quickest traveling distance/time from the bait station.

In some embodiments, a user (e.g., pest controller) receiving the indication may approach bait station 100 and replace the first bait with a second bait (e.g., a poisoned bait).

In operation 450, some embodiments may include receiving a second indication of pest activity at the specific bait station. The second indication may be received after poisoned bait was placed on the bait holder. The second activity may indicate a combination of reduced activity (in comparison to the first indication) while detecting a presence of the pests, indicating a pest was poisoned. For example, sensor 130 located beneath floor 113 may detect a constant load indicating an immobile pest. The pest controller receiving the second indication may approach bait station 100 and remove the immobile pest(s). In some embodiments, processor 220 may send the alert to the user device also based on receipt of the second indication.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A bait station, comprising:
a housing;
a plurality of open channels located in the housing, wherein the plurality of open channels are configured to allow the entrance and the exit of pests to and from an open space within the housing; and
a bait holder located in the open space.

2. The bait station of claim 1, comprising one or more sensors for detecting indications for pests' activity.

3. The bait station of claim 2, wherein the one or more sensors include one of: a sound based sensor, an ultrasound based sensor, heat based sensor, vibration based sensor, movement based sensor, radio frequency based sensor, light based sensor, laser based sensor and weighing scale.

4. The bait station of claim 2, further comprising a controller for receiving indications for pests' activity from the one or more sensors.

5. The bait station of claim 4, further comprising a communication unit and wherein the controller is further configured to send to a central managing unit the received indications via the communication unit.

6. The bait station of claim 1, wherein the housing comprises a removable cover located opposite to the opening of the open channels.

7. The bait station of claim 1, wherein the housing comprises a pests' passage for leading the pest towards the bait holder.

8. The bait station of claim 7, wherein the passage includes a declining floor panel.

9. The bait station of claim 1, wherein the plurality of open channels are arranged in an array form held by the housing.

10. A central managing unit for controlling pests' population, comprising:
a memory; and
a processor to:
receive a first indication of pest activity at a specific bait station;
receive a location of the pest bait station 100 from which the indication was received;
receive localization information of one or more user devices; and
send an alert to the user device based on receipt of the first indication and the receive location.

11. The central managing unit of claim 10, wherein the processor is further configured to:
receive a second indication of pest activity at the specific bait station; and
send the alert to the user device also based on receipt of the second indication.

12. A computer implemented method of for controlling pests' population, comprising:
receiving a first indication of pest activity at a specific bait station;
receiving a location of the pest bait station 100 from which the indication was received;
receiving localization information of one or more user devices; and
sending an alert to the user device based on receipt of the first indication.

13. The computer implemented method of claim 12, further comprising:
receiving a second indication of pest activity at the specific bait station; and
sending the alert to the user device also based on receipt of the second indication.
